(19) United States
(12) Patent Application Publication
(10) Pub. No.: US 2006/0224427 A1
(43) Pub. Date: Oct. 5, 2006

(54) Method, system, and program product for individual and group work space allocation and utilization

(75) Inventor: Glen E. Salmon, Amesbury, MA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/094,027

(22) Filed: Mar. 30, 2005

(51) Int. Cl. G06Q 99/00; G05B 19/418; G06F 9/46

(52) U.S. Cl. 705/8; 705/1

(57) ABSTRACT

The present invention provides a method, system, and computer program product for individual and group work space allocation and utilization. The method comprises: providing a plurality of free spaces in a work environment; and dynamically mapping one of the plurality of free spaces to a user based on a set of mapping criteria.

### BACKGROUND OF THE INVENTION

1. Field of the Invention

The present invention generally relates to computer systems. More particularly, the present invention provides a method, system, and computer program product for individual and group work space allocation and utilization.

2. Related Art

Employers need to provide work spaces to their employees. However, in many environments, not all workers need or want the same work location every day. They need the flexibility to work from different locations—different sites, work from home, work near customers, etc. However, most work environments today do not allow for this level of flexibility and still maintain the necessary services workers need to accomplish their jobs. The most common solution today is to take the percentage of the workforce who need the most flexibility and convert them to “mobile workers,” making every aspect of their environment separate from the company environment (e.g., laptop computers, cell phones, and customized software). Unfortunately, these solutions are too costly to deploy for large portions of a company. Further, current solutions are too restrictive—companies who make the distinction for “mobile workers” do so at the exclusion of working from a formal office; i.e., employees are designated in one category or the other and there is not accommodation for “occasionally mobile” or “occasionally in the office.” The result is that physical office space goes unused when the “occasionally mobile” worker is away from the office. For companies who do support the “occasionally in the office” worker, the solution is to provide use a suboptimal “mobility space” when they visit an office. A system which makes these types of permanent designations, however, can not adapt the changing needs of the work force.

### SUMMARY OF THE INVENTION

In general, the present invention provides a method, system, and computer program product for individual and group work space allocation and utilization.

The present invention assigns free spaces to users from a pool of available free spaces. A mapping system is provided to perform a best match of the type of free space (e.g., cubical, office, conference room, etc.) and the resources/services available in a free space (e.g., phone, computer, speaker phone, number of seats available, etc.) to the needs of each user. The mapping criteria can include direct user input and information gathered from the user's calendar and other personal data systems. The allocation of a free space to a user is dynamic—it may be different from one day/time to the next to take into account different work locations, etc., of the user.

A first aspect of the present invention is directed to a method for work space allocation, comprising: providing a plurality of free spaces in a work environment; and dynamically mapping one of the plurality of free spaces to a user based on a set of mapping criteria.

A second aspect of the present invention is directed to a system for work space allocation, comprising: a system for providing a plurality of free spaces in a work environment; and a system for dynamically mapping one of the plurality of free spaces to a user based on a set of mapping criteria.

A third aspect of the present invention is directed to a program product stored on a computer readable medium for work space allocation, the computer readable medium comprising program code for performing the following steps: providing a plurality of free spaces in a work environment; and dynamically mapping one of the plurality of free spaces to a user based on a set of mapping criteria.

A fourth aspect of the present invention provides a method for deploying an application for work space allocation, comprising: providing a computer infrastructure being operable to: provide a plurality of free spaces in a work environment; and dynamically map one of the plurality of free spaces to a user based on a set of mapping criteria.

A fifth aspect of the present invention provides computer software embodied in a propagated signal for work space allocation, the computer software comprising instructions to cause a computer system to perform the following functions: providing a plurality of free spaces in a work environment; and dynamically mapping one of the plurality of free spaces to a user based on a set of mapping criteria.

### BRIEF DESCRIPTION OF THE DRAWINGS

These and other features of this invention will be more readily understood from the following detailed description of the various aspects of the invention taken in conjunction with the accompanying drawings in which:

FIGS. 1 and 2 depict an illustrative work space allocation system in accordance with an embodiment of the present invention.

FIG. 3 depicts illustrative information used by the mapping system of the work space allocation system of the present invention to allocated free spaces to a user.

FIG. 4 depicts a plurality of sub-systems employed to facilitate the allocation of free spaces to a user in accordance with an embodiment of the present invention.

FIG. 5 depicts a illustrative computer system for implementing a work space allocation system in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, the present invention provides a method, system, and computer program product for individual and group work space allocation and utilization. The work space allocation system of the present invention is configured to assign a free space for each worker who needs one and in the location the free space is needed. The work space allocation system further automates the mapping of services such that coworkers are able to reach each other by phone and when applicable, in person, and handles variations in worker needs such as locations of meetings, phone calls, etc.

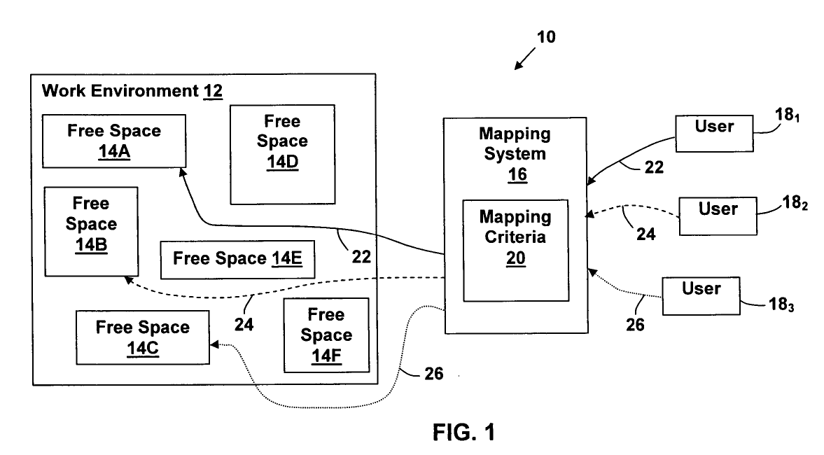

An illustrative work space allocation system 10 in accordance with an embodiment of the present invention is depicted in FIG. 1. As shown, the work space allocation system 10 comprises a work environment 12 including a plurality of free spaces 14 (e.g., 14A-14F), and a mapping system 16 for dynamically allocating a free space 14 to each user 18 (e.g., 18₁-18₃) based on mapping criteria 20. In accordance with the present invention, a “free space” 14 is a work area (e.g., office, conference room, cubicle, presentation room, etc.) with services and an infrastructure (e.g., computer, telephone, telephone/video conferencing equipment, audio/visual equipment, whiteboard, etc.), which allows it to be allocated to a given user 18 at a given time. A user 18 (e.g., worker, visitor, customer, etc.) can be dynamically mapped by mapping system 16 to a free space 14 based on their needs (e.g., location, privacy, security, services, time, size, etc), free space 14 availability and location, as well as other factors. One or more users 18 can be mapped to the same free space 14.

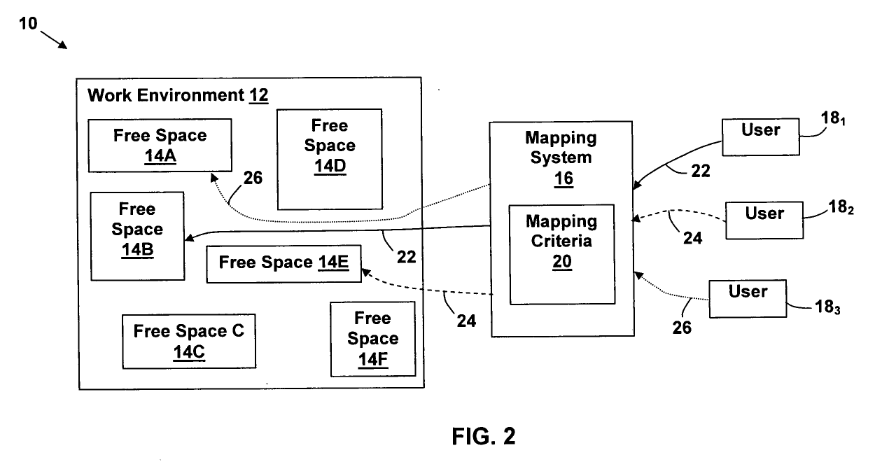

As shown in FIG. 1, on a given day, a first user 18₁ has been mapped to free space 14A by mapping system 16 as indicated by solid arrows 22, while second and third users 18₂ and 18₃ have been mapped to free space 14B and free space 14C as indicated by dashed and dotted arrows 24 and 26, respectively. On another day, however, as shown in FIG. 2, the first user 18₁ has been mapped to free space 14B by mapping system 16 as indicated by solid arrows 22, while second and third users 18₂ and 18₃ have been mapped to free space 14E and free space 14A as indicated by dashed and dotted arrows 24 and 26, respectively.

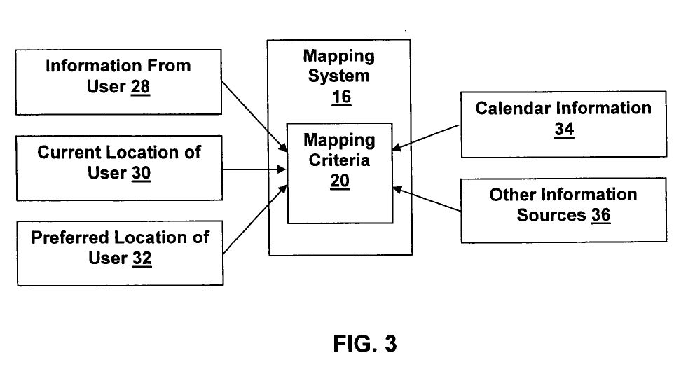

As depicted in FIG. 3, the mapping system 16 is configured to allocate a free space 14 to a user 18 based on, for example, information 28 supplied by the user 18, the current location 30 and preferred location 32 of the user 18, calendar information 34 for the user 18, and information from other sources 36. The information 28 supplied by the user 18 can include, for example, the level of privacy required, the level of security required, the types of services/equipment required, the amount of time a free space 14 is needed, the required size of the free space 14, etc.

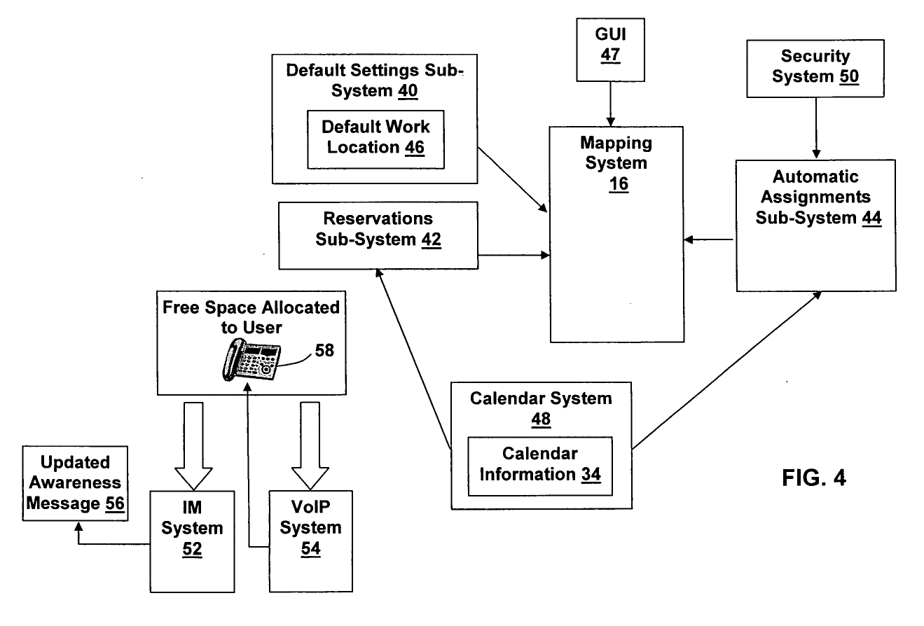

A plurality of sub-systems can be employed to facilitate the allocation of free spaces 14 to a user 18. The following sub-systems are depicted in FIG. 4: default settings sub-system 40, reservations sub-system 42, and automatic assignments sub-system 44. A description of each of the sub-systems 40, 42, and 44 is provided below.

Default Settings Sub-System

Using the default settings sub-system 40, a user 18 can select a default free space 14 (e.g., a default work location 46). Such a default work location 46 provides the user 18 with a regular work location and by default, the user 18 is allocated the same free space 14 from day to day. This helps with the social needs and networking of the user 18 and the building of familiar relationships (e.g., regular interaction at the same water coolers, etc.). For example, assume that a user 18 is scheduled to be in their office on Monday, Wednesday, and Friday of each week, and work from home on Tuesday and Thursday. The user 18 is then provided, by default, with the same office on each Monday, Wednesday, and Friday. On Tuesday and Thursday, however, the user's office 18 becomes “free,” is placed in a pool of free spaces 14, and can be allocated as needed to other users 18 on those days. A user 18 can select a default work location 46 using a graphical user interface (GUI) 47.

Reservations Sub-System

The reservations sub-system 42 allows a user 18 to manually sign up for one or more different locations on a periodic (e.g., daily, weekly, bi-weekly, etc.) or irregular basis. The reservations sub-system 42 can also be integrated with a calendar system 48 of the user 18 to extract calendar information 34 to automatically allocate free spaces 14 for the user 18.

The reservations sub-system 42 is configured to locate and allocate an appropriate free space 14 based on the needs of the user 18. For example, the reservations sub-system 42 can determine, based on the calendar information 34 of the user 18, and information from other sources 36, that the user is traveling to another location of the company on a given day and that an office in that location is needed by the user 18 on that day.

The reservations sub-system 42 can also determine what type of free space 14 (e.g., what type/size cube, office, or conference room, and associated services) is most appropriate based, for example, on calendar information 34 of the user 18. This can be determined by examining the email addresses of the invitees to a meeting scheduled in the calendar of the user 18. For instance, if the email addresses corresponding to a scheduled meeting indicate that all of the invitees to the meeting are located within the same company site, then a basic conference room may be suitable. If the email addresses corresponding to a scheduled meeting indicate that all of the invitees belong to the same company, but that only some of the invitees are located within the same company site, then a conference room with video/telephone conferencing equipment may be suitable. If, however, some of the email addresses are from outside the company, then a more formal conference room may be appropriate since outsiders (e.g., customers) are likely to be in attendance. Many other techniques for determining what type of free space 14 is most appropriate are also possible.

The reservations sub-system 42 can also determine the required size of the free space 14 that is needed based, for example, on the total number of invitees that have accepted an invitation to a meeting. Such information can also be provided by the user 18. Many other techniques for providing information to the reservations sub-system 42 are also possible. For example, the reservations sub-system 42 can request that the user 18 enter the information directly into a graphical user interface (e.g., GUI 47).

Automatic Assignments Sub-System

The work space allocation system 10 of the present invention can also be integrated with a security system 50. For example, when a user 18 “badges in” to a facility via the security system 50 (e.g., using a card reader, Radio Frequency Identification (RFID), etc.), the automatic assignments sub-system 44 checks to see if the user 18 has a free space 14 assigned in the facility. If the user 18 has not requested or has not been assigned a free space 14 in the facility (e.g., by the reservations sub-system 42), the user is given the option, when entering the facility, to indicate whether they are visiting or need a free space 14 assignment. If the user 18 indicates that they need a free space 14 assignment, the automatic assignments sub-system 44 allocates a suitable free space 14 for the user 18. The automatic assignments sub-system 44 can examine the calendar information 34 for the day from the user's calendar system 48 (and information from other sources 36) to make a suitable free space 14 allocation. Alternatively, the user 18 can manually input their free space 14 requirements and can be allocated a suitable free space 14 based on their requirements.

If there is an existing free space 14 reservation at another location for the user 18, the user 18 is asked if that existing free space 14 reservation can be cancelled for the duration of the user's 18 time at the current facility. If so, the free space 14 reserved for the user 18 at the other location is returned to the pool of free spaces 14, where it can be allocated as needed to another user 18.

The work space allocation system 10 of the present invention can also be integrated with various corporate systems. For example, as shown in FIG. 4, an instant messaging (IM) system 52 can be notified by the work space allocation system 10 to update the awareness message 56 for the user 18 to indicate the user's current location. In addition, a Voice Over Internet Protocol (VOIP) Private Branch Exchange (PBX) 54 can be notified to automatically map the VoIP phone number of the user 18 to a physical phone 58 in the allocated free space 14. In this way, the user 18 can always be reached regardless of the free space 14 that has been allocated to the user 18.

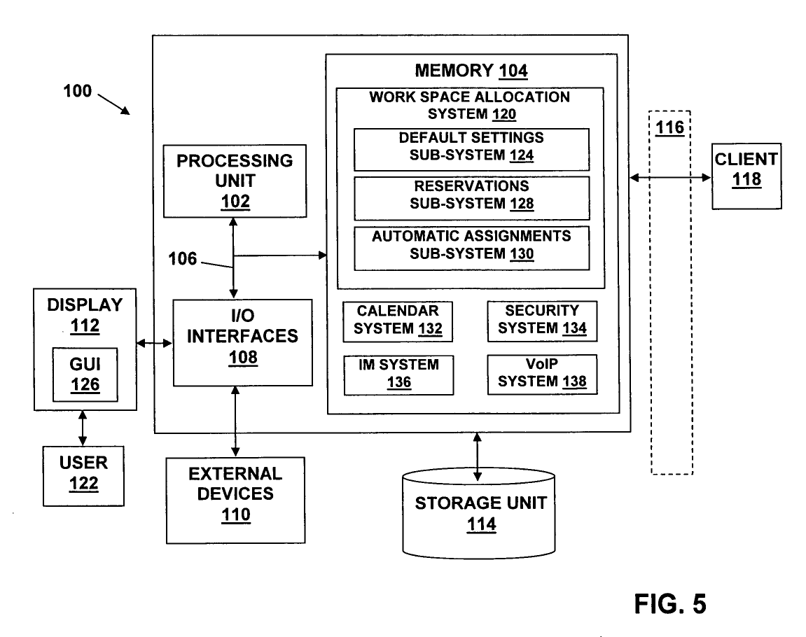

A computer system 100 for providing work space allocation in accordance with an embodiment of the present invention is depicted in FIG. 5. Computer system 100 generally includes a processing unit 102, memory 104, bus 106, input/output (I/O) interface(s) 108, and external devices/resource(s) 110. Processing unit 102 may comprise a single processing unit, or may be distributed across one or more processing units in one or more locations. Memory 104 may comprise any known type of data storage and/or transmission media, including magnetic media, optical media, random access memory (RAM), read-only memory (ROM), etc. Moreover, similar to processing unit 102, memory 104 may reside at a single physical location, comprising one or more types of data storage, or be distributed across a plurality of physical systems in various forms.

I/O interface(s) 108 may comprise any system for exchanging information to/from an external source. External devices/resource(s) 110 may comprise any known type of external device, including speakers, a handheld device, keyboard, mouse, voice recognition system, speech output system, printer, monitor/display (e.g., display 112), facsimile, pager, etc.

Bus 106 provides a communication link between each of the components in computer system 100, and likewise may comprise any known type of transmission link, including electrical, optical, wireless, etc. In addition, although not shown, additional components, such as cache memory, communication systems, system software, etc., may be incorporated into computer system 100.

Data (e.g., calendar information 34, free space 14 allocations, reservation requests, default work locations, etc.) used in the practice of the present invention can be stored locally to computer system 100, for example, in storage unit 114, and/or may be provided to computer system 100 over a network 116. Storage unit 114 can be any system capable of providing storage for data and information under the present invention. As such, storage unit 114 may reside at a single physical location, comprising one or more types of data storage, or may be distributed across a plurality of physical systems in various forms. In another embodiment, storage unit 114 may be distributed across, for example, a local area network (LAN), wide area network (WAN) or a storage area network (SAN) (not shown).

Network 116 is intended to represent any type of network over which data can be transmitted. For example, network 116 can include the Internet, a wide area network (WAN), a local area network (LAN), a virtual private network (VPN), a WiFi network, or other type of network. To this extent, communication can occur via a direct hardwired connection or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server. One or more client devices 118 may be connected to computer system 100 via network 116. Each client device 118 comprises components similar to those described above with regard to computer system 100.

Shown in memory 104 as a computer program product is a work space allocation system 120 for allocating free spaces 14 to one or more users 122 in accordance with the present invention. Work space allocation system 120 includes a default settings sub-system 124 that allows a user 122 to select a default work location (e.g., via a GUI 126 on display 112). Also shown in memory 104 is a reservations sub-system 128 and an automatic assignments sub-system 130. As detailed above, the reservations sub-system 128 can be used by a user 122 to manually sign up (e.g., via GUI 126) for one or more different free spaces 14 on a periodic or irregular basis. The reservations sub-system 128 can also be integrated with a calendar system 132 of a user 122 to extract calendar information that is used to automatically allocate free spaces 14 for the user 122.

The automatic assignments sub-system 130 can be used, for example, in conjunction with a security system 134 to allocate a free space 14 to a user 122 when the user enters a facility. If the user 122 indicates that they need a free space 14 assignment after entering the facility, the automatic assignment sub-system 130 allocates a suitable free space 14 for the user 122. If there is an existing free space 14 reservation at another location for the user 122, the user 122 is asked if that existing free space 14 reservation can be cancelled for the duration of the user's 122 time at the current facility. If so, the free space 14 reserved for the user 122 at the other location is returned to the pool of free spaces 14, where it can be allocated as needed to another user 122.

The work space allocation system 120 can also be integrated with an IM system 136 and VoIP system 138. For example, IM system 136 can be notified by the work space allocation system 120 to update the awareness message for the user 122 to indicate the user's current location. The VoIP system 138 can be used to automatically map the VoIP phone number of the user 122 to a physical phone in the assigned free space 14 currently assigned to the user 122.

It should be appreciated that the teachings of the present invention can be offered as a business method on a subscription or fee basis. For example, one or more components of the present invention could be created, maintained, supported, and/or deployed by a service provider that offers the functions described herein for customers. That is, a service provider could be used to provide work space allocation, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for work space allocation, comprising:
providing a plurality of free spaces in a work environment; and
dynamically mapping one of the plurality of free spaces to a user based on a set of mapping criteria.

2. The method of claim 1, further comprising:
selecting a default free space for the user in a default work location of the work environment; and
automatically allocating the default free space to the user when the user is in the default work location.

3. The method of claim 2, further comprising:
returning the default work location to a pool of free spaces when the user is not in the default work location; and
reallocating the default free space to another user.

4. The method of claim 1, further comprising:
reserving one of the plurality of free spaces in a work location of the work environment and inputting user requirements for the reserved free space; and
allocating one of the plurality of free spaces in the work location to the user based on the user requirements.

5. The method of claim 4, wherein the user requirements are selected by the user.

6. The method of claim 4, further comprising:
extracting calendar information for the user; and
automatically determining the user requirements based on the extracted calendar information.

7. The method of claim 1, further comprising:
identifying the user when the user enters a work location in the work environment; and
determining if one of the plurality of free spaces has been allocated to the user in the work location.

8. The method of claim 7, further comprising:
determining if the user requires a free space in the work location; and
allocating one of the plurality of free spaces in the work location to the user if the user requires a free space in the work location.

9. The method of claim 8, wherein the step of allocating one of the plurality of free spaces in the work location to the user further comprises:
determining user requirements for the free space in the work location.

10. The method of claim 8, wherein the user requirements are selected by the user.

11. The method of claim 8, further comprising:
determining if another free space has been allocated to the user in another work location in the work environment;
if another free space has been allocated to the user, returning the other free space to a pool of free spaces; and
reallocating the other free space to another user.

12. The method of claim 1, further comprising:
updating an instant messaging system to indicate a location of the free space allocated to the user.

13. The method of claim 1, further comprising:
mapping a phone number of the user to a phone in the free space allocated to the user.

14. Deploying an application for work space allocation, comprising:
providing a computer infrastructure being operable to perform the method of claim 1.

15. Computer software embodied in a propagated signal for work space allocation, the computer software comprising instructions to cause a computer system to perform the method of claim 1.

16. A system for work space allocation, comprising:
a system for providing a plurality of free spaces in a work environment; and
a system for dynamically mapping one of the plurality of free spaces to a user based on a set of mapping criteria.

17. The system of claim 16, further comprising:
a system for selecting a default free space for the user in a default work location of the work environment; and
a system for automatically allocating the default free space to the user when the user is in the default work location.

18. The system of claim 17, further comprising:
a system for returning the default work location to a pool of free spaces when the user is not in the default work location; and
a system for reallocating the default free space to another user.

19. The system of claim 16, further comprising:
a system for reserving one of the plurality of free spaces in a work location of the work environment and inputting user requirements for the reserved free space; and
a system for allocating one of the plurality of free spaces in the work location to the user based on the user requirements.

20. The system of claim 19, wherein the user requirements are selected by the user.

21. The system of claim 19, further comprising:
a system for extracting calendar information for the user; and
a system for automatically determining the user requirements based on the extracted calendar information.

22. The system of claim 16, further comprising:
a system for identifying the user when the user enters a work location in the work environment; and
a system for determining if one of the plurality of free spaces has been allocated to the user in the work location.

23. The system of claim 22, further comprising:
a system for determining if the user requires one of the plurality of free spaces in the work location; and
a system for allocating one of the plurality of free spaces in the work location to the user if the user requires a free space in the work location.

24. The system of claim 23, wherein the system for allocating one of the plurality of free spaces in the work location to the user further comprises:
a system for determining user requirements for the free space in the work location.

25. The system of claim 23, wherein the user requirements are selected by the user.

26. The system of claim 23, further comprising:
a system for determining if another free space has been allocated to the user in another work location in the work environment;
a system for returning the other free space to a pool of free spaces, if another free space has been allocated to the user; and
a system for reallocating the other free space to another user.

27. The system of claim 16, further comprising:
a system for updating an instant messaging system to indicate a location of the free space allocated to the user.

28. The system of claim 16, further comprising:
a system for mapping a phone number of the user to a phone in the free space allocated to the user.

29. A program product stored on a computer readable medium for work space allocation, the computer readable medium comprising program code for performing the following steps:
providing a plurality of free spaces in a work environment; and
dynamically mapping one of the plurality of free spaces to a user based on a set of mapping criteria.
